(19) United States
(12) Patent Application Publication
(10) Pub. No.: US 2026/0177885 A1
(43) Pub. Date: Jun. 25, 2026

(54) CAMERA MODULE

(71) Applicant: SAMSUNG ELECTRO-MECHANICS CO., LTD., Suwon-si (KR)

(72) Inventors: Hwahyun JEON, Suwon-si (KR); Youngan CHOI, Suwon-si (KR)

(73) Assignee: SAMSUNG ELECTRO-MECHANICS CO., LTD., Suwon-si (KR)

(21) Appl. No.: 19/383,869

(22) Filed: Nov. 10, 2025

(30) Foreign Application Priority Data
Dec. 24, 2024 (KR) 10-2024-0195381

(51) Int. Cl. G03B 17/02; G03B 30/00

(52) U.S. Cl. CPC G03B 17/02; G03B 30/00

(57) ABSTRACT

A camera module includes a housing; a circuit board on which an image sensor is mounted; a driving member, coupled to the circuit board, configured to move the circuit board; an elastic member, connected to the housing, configured to support the circuit board; and a guide member configured to guide a movement of the circuit board.

### CROSS-REFERENCE TO RELATED APPLICATIONS

This application claims the benefit under 35 USC 119(a) of Korean Patent Application No. 10-2024-0195381 filed on December 24, 2024, in the Korean Intellectual Property Office, the entire disclosure of which is incorporated herein by reference for all purposes.

### BACKGROUND

### 1. Field

The present disclosure relates to a camera module.

### 2. DESCRIPTION OF THE BACKGROUND

Ultra-compact camera modules are used in vehicles. For example, ultra-compact cameras may be adopted for black box cameras for vehicle protection or objective data of traffic accidents, rear surveillance cameras that allow drivers to monitor the blind spot at the rear of the vehicle through a screen to ensure safety when moving the vehicle reversely, and perimeter detection cameras that can monitor the vehicle's surroundings.

Automotive camera modules may be exposed to everything ranging from sub-zero temperatures to intense heat. When automotive camera modules are exposed to temperature changes, the distance from the lens to the image module may change significantly. That is, as the temperature of the environment surrounding the camera module rises, internal components of the camera module, such as the lens, may expand, causing the focal length to change. Therefore, a technique may be desired to compensate for the focal length changes.

Previously, a voice coil motor (VCM)-type actuator was used to compensate for the focal length change. However, the VCM-type actuator has the disadvantages of being vulnerable to foreign substances because of a gap between a lens barrel and a housing, being expensive, and making the camera module larger.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing; a circuit board on which an image sensor is mounted; a driving member, coupled to the circuit board, configured to move the circuit board; an elastic member, connected to the housing, configured to support the circuit board; and a guide member configured to guide a movement of the circuit board.

The guide member may be configured to guide the circuit board to move in an optical axis direction, and prevent the circuit board from moving in a direction intersecting the optical axis direction.

The driving member may include a shape memory alloy.

The driving member may be connected to the guide member and an upper surface of the circuit board.

The driving member may gradually expand as temperature decreases, at least, within a certain temperature range.

The elastic member may be disposed under the circuit board.

The guide member may include a body portion coupled to a lower portion of the housing, a neck portion disposed on the body portion, and a head portion disposed on the neck portion.

The neck portion may have a shape that widens from the body portion toward the head portion.

One side of the driving member may be connected to a lower surface of the head portion.

The driving member may be connected to the guide member and a lower surface of the circuit board.

The driving member may gradually expand as the temperature increases, at least within a certain temperature range.

The elastic member may be disposed on the circuit board.

The guide member may include a body portion coupled to an upper portion of the housing, a neck portion disposed under the body portion, and a head portion positioned under the neck portion.

One side of the driving member may be connected to an upper surface of the head portion.

Other features and aspects will be apparent from the following detailed description, the drawings, and the claims.

### BRIEF DESCRIPTION OF THE DRAWINGS

FIG. 1 is a perspective view illustrating the appearance of a camera module according to an embodiment.

FIG. 2 is an exploded perspective view of a camera module according to an embodiment.

FIG. 3 is a schematic view showing the state of a camera module according to an embodiment at high temperatures.

FIG. 4 is a schematic view showing the state of a camera module according to the present embodiment at room temperature.

FIG. 5 is an enlarged view of a guide member of FIGS. 3 and 4.

FIG. 6 is a schematic view showing the state of a camera module according to another embodiment at high temperatures.

FIG. 7 is a schematic view showing the state of a camera module according to another embodiment at low temperatures.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

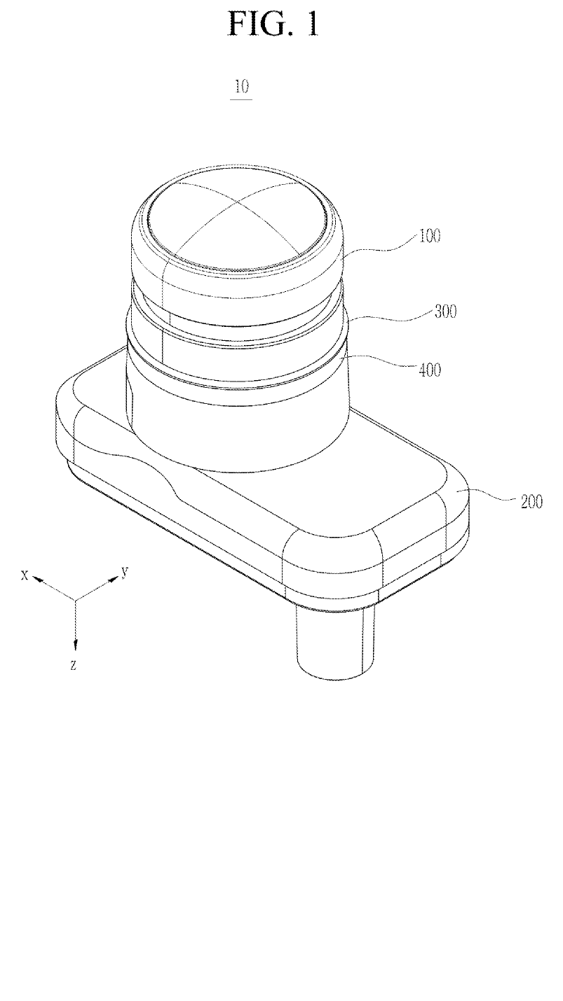

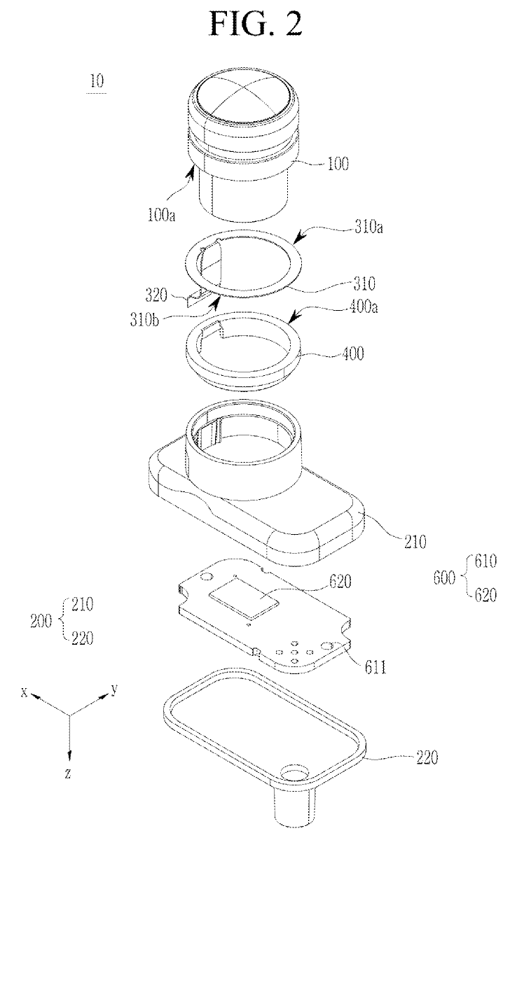

FIG. 1 is a perspective view illustrating the appearance of a camera module 10 according to an embodiment. FIG. 2 is an exploded perspective view of the camera module 10 according to an embodiment.

Referring to FIGS. 1 and 2, the camera module 10, according to the present embodiment, may include a lens barrel 100, a housing 200, a heating portion 300, an insulation member 400, and a substrate portion 600.

The lens barrel 100 may be disposed in the housing 200. The lens barrel 100 may be at least partially accommodated in the housing 200. The lens barrel 100 may be partially inserted into an opening of the housing 200 and positioned inside the housing 200, while another part may be disposed on the housing 200.

The lens barrel 100 may have different diameters at the upper portion and the lower portion. That is, the lens barrel 100 may have different widths at the upper portion and the lower portion when measured in a direction perpendicular to the optical axis. The lens barrel 100 may have a larger diameter at the upper portion than at the lower portion. The lens barrel 100 may have a step formed between the upper and lower portions, and a first surface 100a, which is a step surface, may be positioned between the upper and lower portions. The first surface 100a may be perpendicular to the optical axis direction (Z-axis direction). The first surface 100a may be supported by the housing 200.

For example, the lens barrel 100 may be screw-coupled to the inner circumference of the housing 200. Corresponding screw threads for screw-coupling may be formed on the outer circumference of the lens barrel 100 and the inner circumference of the housing 200 facing each other.

The lens barrel 100 may accommodate at least one lens. Each lens accommodated in the lens barrel 100 may be manufactured using a synthetic resin material, a glass material, or a quartz material. However, the materials of the lenses are not limited thereto.

The camera module 10 may include the housing 200. The housing 200 may form at least a part of the exterior of the camera module 10. A part of the lens barrel 100 and the substrate portion 600 may be disposed inside the housing 200. The insulation member 400 may be disposed on the housing 200.

The housing 200 may include the upper housing 210 and the lower housing 220. The upper housing 210 may be disposed on the lower housing 220. An opening may be formed on the upper surface of the upper housing 210, through which a part of the lens barrel 100 may be inserted into the housing 200. The inner surface of the housing 200 may be spaced apart from the lens barrel 100, positioned within the housing 200 by a predetermined distance.

The lower housing 220 may be disposed under the upper housing 210. The lower housing 220 may be coupled to the upper housing 210. The upper housing 210 may be formed integrally with the lower housing 220.

The insulation member 400 may be disposed on the housing 200. A heating substrate 310 of the heating portion 300 may be disposed on the insulation member 400. The insulation member 400 may prevent heat loss by blocking heat generated by the heating substrate 310 from being transmitted to the housing 200. That is, the insulation member 400 may improve the rate at which heat generated by the heating substrate 310 is transmitted to the lens barrel 100.

The insulation member 400 may be positioned along at least a part of the circumference of the lens barrel 100. The insulation member 400 may be positioned to surround at least a part of the lens barrel 100. A part of the insulation member 400 may be inserted into the housing 200 and coupled to the housing 200. The insulation member 400 may have a donut shape with a hollow space formed therein. The lens barrel 100 may be inserted into the hollow space. The insulation member 400 may have a shape corresponding to the heating substrate 310. Accordingly, the area of contact between the insulation member 400 and the heating substrate 310 increases, so that heat generated by the heating substrate 310 may be more effectively blocked from being transmitted to the housing 200. However, the shape of the insulation member 400 is not limited thereto, and the shape of the insulation member 400 may be any shape into which the lens barrel 100 may be inserted.

The insulation member 400 may have a second surface 400a facing the first surface 100a. The insulation member 400 may have a shape extending in a direction perpendicular to the optical axis from the inserted lens barrel 100. The second surface 400a may be perpendicular to the optical axis direction (Z-axis direction). The second surface 400a may extend in a direction perpendicular to the optical axis.

For example, the insulation member 400 may be formed of a ceramic-, plastic-, or silicone-based material. However, this is an example, and the material of the insulation member 400 may be any material with a low heat transfer coefficient.

The heating portion 300 may include the heating substrate 310 and an electrical transmission member 320.

The heating substrate 310 may be positioned on the insulation member 400. The heating substrate 310 may be positioned along the circumference of the lens barrel 100. The heating substrate 310 may be disposed to surround a part of the lens barrel 100. The heating substrate 310 may have a ring shape. The lens barrel 100 may be inserted into the heating substrate 310. That is, a hollow space is formed in the heating substrate 310, and the heating substrate 310 may have a shape that extends outward from the outer circumference of the lens barrel 100 inserted into the hollow space. The heating substrate 310 may have a shape corresponding to the insulation member 400. The heating substrate 310 may have a third surface 310a facing the first surface 100a and a fourth surface 310b facing the second surface 400a. The third surface 310a may be coupled to the first surface 100a of the lens barrel 100, and the fourth surface 310b may be coupled to the second surface 400a of the insulation member 400. The third surface 310a may be bonded to the first surface 100a of the lens barrel 100 by an adhesive member. The fourth surface 310b may be bonded to the fourth surface 310b of the insulation member 400 by an adhesive member. In FIG. 2, the heating substrate 310 is illustrated as having a ring shape but is not limited thereto. The shape of the heating substrate 310 may be any shape in which an opening is formed into which the lens barrel 100 may be inserted. The electrical transmission member 320 may be electrically connected to the heating substrate 310. The electrical transmission member 320 may be coupled to a circuit board 610. The electrical transmission member 320 may be electrically connected to the circuit board 610. The electrical transmission member 320 may be connected to a power source disposed on the circuit board 610. The electrical transmission member 320 may transmit electricity from the circuit board 610 to the heating substrate 310.

The electrical transmission member 320 may be connected to the heating substrate 310 on the inner side of the heating substrate 310. The electrical transmission member 320 may be coupled to the heating substrate 310 through a portion where a hollow space is formed in the heating substrate 310. The electrical transmission member 320 may have a portion extending in the optical axis direction (Z-axis direction) from the heating substrate 310. The electrical transmission member 320 may have a portion positioned in the internal space of the insulation member 400. The electrical transmission member 320 may have a portion positioned in the internal space of the housing 200. The electrical transmission member 320 may extend from the heating substrate 310 toward the substrate along the internal space of the insulation member 400 and the internal space of the housing 200. The electrical transmission member 320 may be connected to the edge portion of the circuit board 610. The electrical transmission member 320 may have a shape that is at least partially bent. The shape in which the electrical transmission member 320 is bent may correspond to the internal shape of the housing 200.

The substrate portion 600 may be disposed inside the housing 200. The substrate 600 may include the circuit board 610 and an image sensor 620.

The substrate portion 600 may include the circuit board 610. The circuit board 610 may be disposed under the lens barrel 100. The circuit board 610 may include a printed circuit board (PCB) or a flexible printed circuit board (FPCB).

The image sensor 620 may be mounted on the circuit board 610. The image sensor 620 may be electrically connected to the substrate. The image sensor 620 may be disposed on the front or upper surface of the substrate. For example, the image sensor 620 may be coupled to the substrate using surface-mount technology (SMT). As another example, the image sensor 620 may be bonded to the substrate using flip chip technology. The image sensor 620 may be aligned to the lens barrel 100 in the optical axis direction (Z-axis direction).

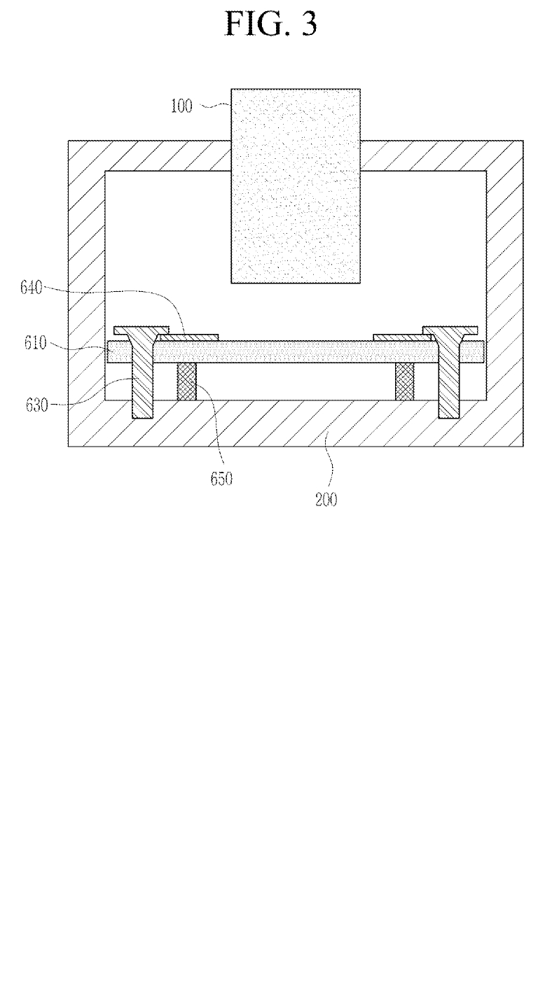

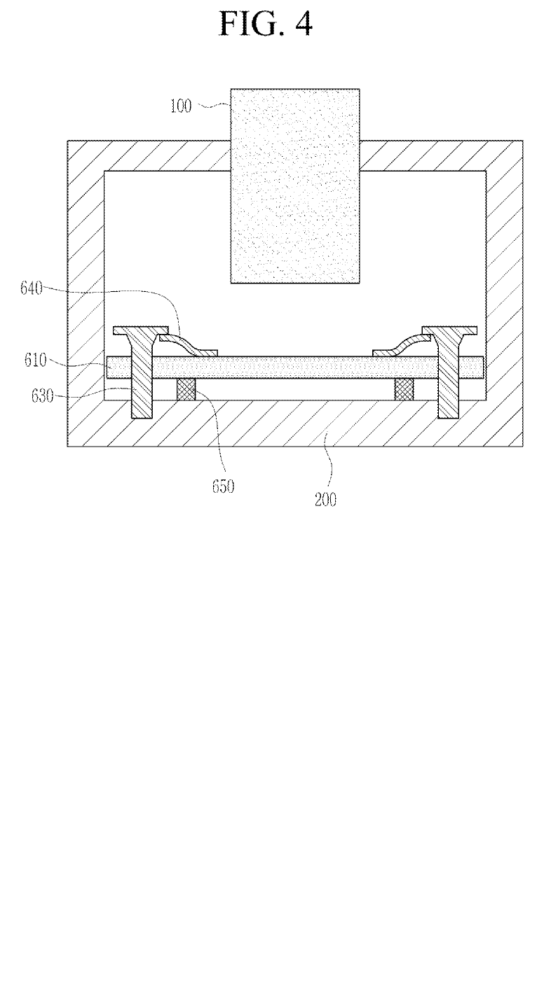

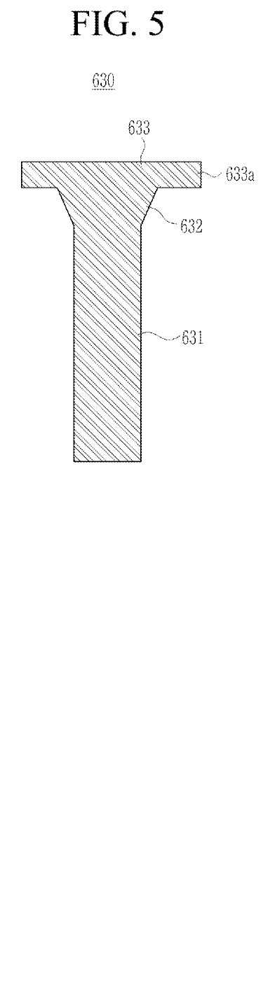

FIG. 3 is a schematic view showing the state of the camera module 10 according to the present embodiment at high temperatures. FIG. 4 is a schematic view showing the state of the camera module 10 according to the present embodiment at low temperatures. FIG. 5 is an enlarged view of the guide member 630 of FIGS. 3 and 4.

Referring to FIGS. 3 and 4, the substrate portion 600 includes the circuit board 610, the guide member 630, the driving member 640, and the elastic member 650.

The guide member 630 guides the circuit board 610 to move in the optical axis direction (Z-axis direction). Additionally, the guide member 630 may restrict the circuit board 610 from moving in a direction intersecting the optical axis direction (Z-axis direction). The guide member 630 may penetrate a hole 611 of the circuit board 610 and be connected to the housing 200. The circuit board 610 may move in the optical axis direction (Z-axis direction) along the guide member 630. That is, by inserting the guide member 630 into the cavity of the circuit board 610, the horizontal position of the circuit board 610―the position in the direction intersecting or perpendicular to the optical axis direction (Z-axis direction) ―may be affixed. The guide member 630 may guide the movement of the circuit board 610. The circuit board 610 may move in the optical axis direction (Z-axis direction) along the guide member 630. The guide member 630 may be coupled to the lower portion of the housing 200. For example, the guide member 630 may be screw-coupled to a cavity formed in the lower portion of the housing 200. In this case, corresponding screw threads may be formed in the cavity formed in the guide member 630 and the lower portion of the housing 200. As another example, the guide member 630 may be inserted into a cavity formed in the lower portion of the housing 200 and coupled to the housing 200 by an adhesive.

Referring to FIG. 5, the guide member 630 may include a body portion 631, a head portion 633, and a neck portion 632.

The body portion 631 of the guide member 630, according to the present embodiment, is positioned at the lower portion of the guide member 630. The body portion 631 may be inserted into the cavity of the circuit board 610. The circuit board 610 may move in the optical axis direction (Z-axis direction) along the body portion 631.

The shape of the body portion 631 may correspond to the shape of the hole 611 of the circuit board 610. For example, the hole 611 of the circuit board 610 may be formed in a circular shape, and the body portion 631 may have a cylindrical shape corresponding to the hole 611. However, the shape of the body portion 631 is not limited thereto, and the body portion 631 may have a columnar shape with a cross-section that is a polygon such as a quadrangle.

The lower portion of the body portion 631 may be coupled to the housing 200. The lower portion of the body portion 631 may be inserted into a hole formed at the lower portion of the housing 200 and affixed to the housing 200. For example, the body portion 631 may be coupled to the hole of the housing 200 using an adhesive. As another example, corresponding screw threads are formed at the lower portion of the body portion 631 and the hole of the housing 200, so that the body portion 631 and the hole of the housing 200 may be screw-coupled. By securing the body portion 631 to the housing 200, a plane direction (X-Y plane direction) position of the circuit board 610 may be affixed.

The neck portion 632 of the guide member 630 is positioned on the body portion 631. The neck portion 632 may have a shape that gradually widens from the body portion 631 toward the head portion 633. The neck portion 632 may serve as a stopper when the circuit board 610 rises upward. Since the neck portion 632 has a shape that gradually widens toward the head portion 633, the impact when the circuit board 610 is raised and then stopped by the neck portion 632 may be alleviated.

The head portion 633 of the guide member 630 is positioned on the neck portion 632. The head portion 633 may have a larger plane area than the upper surface of the neck portion 632. The head portion 633 may completely cover the neck portion 632. The head portion 633 may include a protrusion 633a that protrudes further outward based on the upper surface of the neck portion 632.

The driving member 640 may be positioned on the upper surface of the circuit board 610. Additionally, the driving member 640 may be coupled to the guide member 630. In other words, the driving member 640 may be connected to the upper surface of the circuit board 610 and the guide member 630. The driving member 640 may have one side in contact with the upper surface of the circuit board 610 and the other side attached to the lower surface of the protrusion 633a of the guide member 630. The driving member 640 may apply pressure to the circuit board 610 as the driving member 640 expands while being affixed to one side by the guide member 630.

The driving member 640 may include a shape memory alloy (SMA). Referring to FIG. 4, the driving member 640 may apply downward pressure to the circuit board 610 by utilizing the extension of the shape memory alloy. For example, the driving member 640 may expand at room temperature to have an arch shape and contract at high temperature to have a flat plate shape. That is, at least within a certain temperature range, the driving member 640 may gradually expand as the temperature decreases.

The elastic member 650 may be positioned under the circuit board 610. The elastic member 650 may be connected to the lower portion of the housing 200 and support the circuit board 610 from below. The circuit board may be raised by the elastic member 650. When the driving member 640 contracts, the circuit board 610 may be raised by the elastic force of the elastic member 650. For example, the elastic member 650 may have a cavity formed therein. The body portion 631 of the guide member 630 may be inserted into a cavity inside the elastic member 650.

For example, if the interior of the camera module 10 is exposed to a high-temperature environment, the driving member 640 may shrink. In a low-temperature environment, the driving member 640 may expand and apply pressure to the circuit board 610. The pressurized circuit board 610 may be lowered along the body portion 631 of the guide member 630. The degree of extension of the driving member 640 may be linked to the temperature inside the camera module 10. As the internal temperature of the camera module 10 rises, the driving member 640 may contract, and the circuit board 610 may rise along the body portion 631 of the guide member 630 due to the restoring force of the elastic member 650.

Each component of the camera module 10 may expand in a high-temperature environment and contract in a low-temperature environment. Accordingly, the distance between the lens and the image module may be longer in a low-temperature environment than in a high-temperature environment. The change in distance may be compensated for by the circuit board 610 being moved up and down by the driving member 640 and the elastic member 650, as described above.

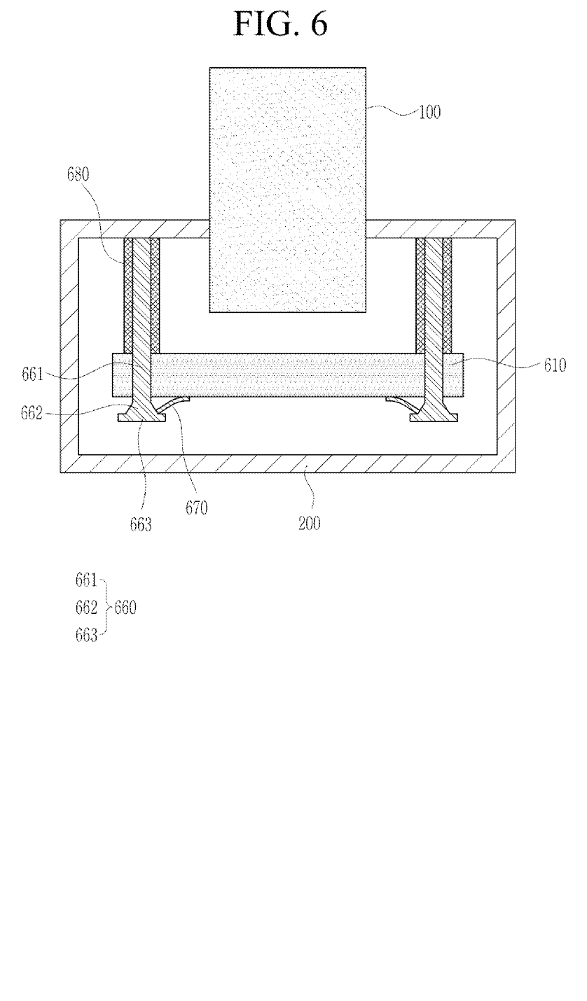

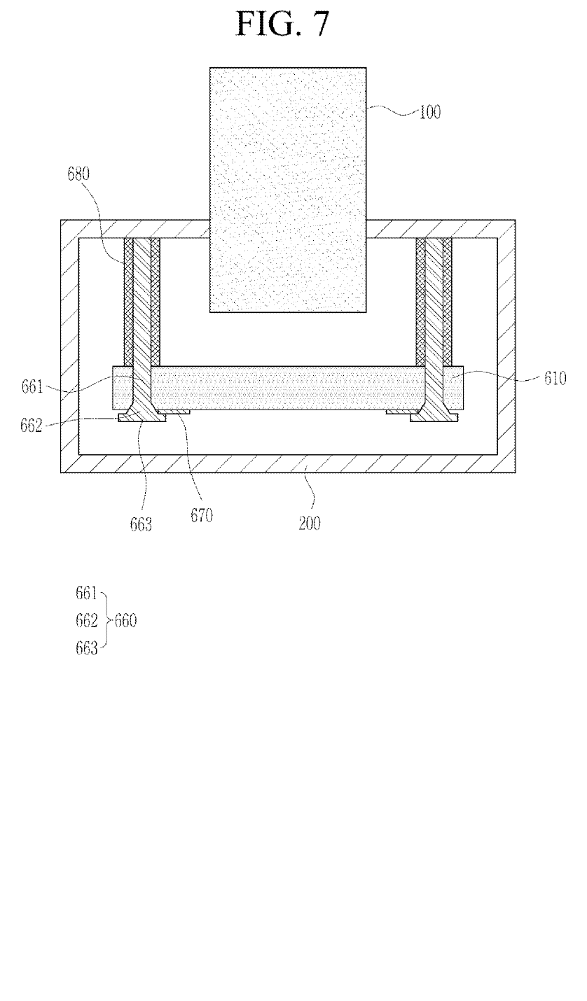

Below, a camera module according to another embodiment is described with reference to FIGS. 6 and 7.

FIG. 6 is a schematic view showing the state of the camera module according to the present embodiment at high temperatures. FIG. 7 is a schematic view showing the state of the camera module according to the present embodiment at low temperatures. The camera module, according to the present embodiment, is similar to the camera module of the embodiment described with reference to FIGS. 3 to 5. Detailed descriptions of the same components are omitted.

Referring to FIGS. 6 and 7, the substrate portion 600 of the camera module of the present embodiment includes the circuit board 610, a guide member 660, a driving member 670, and an elastic member 680.

The guide member 660 guides the circuit board 610 to move in the optical axis direction (Z-axis direction). Additionally, the guide member 660 may prevent the circuit board 610 from moving in a direction intersecting the optical axis direction (Z-axis direction). The guide member 660 may penetrate the hole 611 of the circuit board 610 and be connected to the housing 200. The circuit board 610 may move in the optical axis direction (Z-axis direction) along the guide member 660. That is, by inserting the guide member 660 into the cavity of the circuit board 610, the horizontal position of the circuit board 610―the position in the direction intersecting or perpendicular to the optical axis direction (Z-axis direction) ―may be affixed. The guide member 660 may guide the movement of the circuit board 610. The circuit board 610 may move in the optical axis direction (Z-axis direction) along the guide member 660. The guide member 660 may be coupled to the upper portion of the housing 200. For example, the guide member 660 may be screw-coupled to a cavity formed in the upper portion of the housing 200. In this case, corresponding screw threads may be formed in the cavity formed in the guide member 660 and the upper portion of the housing 200. As another example, the guide member 660 may be inserted into a cavity formed in the upper portion of the housing 200 and coupled to the housing 200 by an adhesive. The guide member 660 may at least partially penetrate the elastic member 680.

The guide member 660 may include a body portion 661, a neck portion 662, and a head portion 663.

One side of the body portion 661 of the guide member 660 may be coupled to the housing 200. One side of the body portion 661 may be inserted into a hole formed in the upper portion of the housing 200 and affixed to the housing 200. For example, the body portion 661 may be coupled to the hole of the housing 200 using an adhesive. As another example, corresponding screw threads are formed on one side of the body portion 661 and the hole of the housing 200, so that the body portion 661 and the hole of the housing 200 may be screw-coupled. By affixing the body portion 661 to the housing 200, a plane direction (X-Y plane direction) position of the circuit board 610 may be affixed. For example, the body portion 661 of the guide member 660 may be at least partially inserted into the interior of the elastic member 680.

The neck portion 662 of the guide member 660 may extend downward from the other side of the body portion 661. The neck portion 662 may have a shape that gradually widens from the body portion 661 toward the head portion 663. The neck portion 662 may serve as a stopper when the circuit board 610 is lowered downward. Since the neck portion 662 has a shape that gradually widens toward the head portion 663, the impact when the circuit board 610 is lowered and then stopped by the neck portion 662 may be alleviated.

The head portion 663 of the guide member 660 extends downward from the neck portion 662. The head portion 663 may have a larger plane area than the upper surface of the neck portion 662. The head portion 663 may include the protrusion 633a that protrudes further outward based on the upper surface of the neck portion 662.

The driving member 670 may be positioned on the lower surface of the circuit board 610. Additionally, the driving member 670 may be coupled to the guide member 660. The driving member 670 may have one side in contact with the upper surface of the circuit board 610 and the other side attached to the upper surface of the protrusion 633a of the guide member 660.

The driving member 670 may include the shape memory alloy (SMA). The driving member 670 may apply upward pressure to the circuit board 610 by utilizing the extension of the shape memory alloy. For example, the driving member 670 may expand at high temperature to have an arch shape and contract at room temperature to have a flat plate shape. That is, at least within a certain temperature range, the driving member 670 may gradually expand as the temperature increases.

The elastic member 680 may be positioned on the circuit board 610. The elastic member 680 may be connected to the upper portion of the housing 200 and support the circuit board 610 from above. The circuit board 610 may be raised by the elastic member 680. When the driving member 670 contracts, the circuit board 610 may be lowered by the elastic force of the elastic member 680. For example, the elastic member 680 may have a cavity formed therein. The body portion 661 of the guide member 660 may be inserted into the cavity inside the elastic member 680.

For example, if the interior of the camera module is exposed to a high-temperature environment, the driving member 670 may expand. As the driving member 670 expands, the circuit board 610 may be pressed and raised along the body portion 661 of the guide member 660. The degree of extension of the driving member 670 may be linked to the temperature inside the camera module 10. As the temperature inside the camera module decreases, the driving member 670 may contract. When the driving member 670 contracts, the circuit board 610 may be lowered along the body portion 661 of the guide member 660 by the restoring force of the elastic member 680.

According to at least one embodiment of the present disclosure, the focal length may be adjusted by moving the circuit board up and down using the shape memory alloy. Accordingly, the focal length may be adjusted without the gap between a lens barrel and a housing that is present in VCM-type actuators.

In addition, since the driving member expands and contracts in response to temperature changes, a separate temperature sensor or controller may not be desired for focal length compensation according to temperature changes. When no temperature sensor or controller is desired, the reliability of focal length compensation may be maintained even at high temperatures.

In addition, when the components desired to drive the circuit board are relatively small, the camera module may be miniaturized when compared to the VCM driving type.

One or more embodiments attempt to provide a camera module capable of adjusting the focal length by moving a substrate up and down using a shape memory alloy.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a housing;
a circuit board on which an image sensor is mounted;
a driving member, coupled to the circuit board, configured to move the circuit board;
an elastic member, connected to the housing, configured to support the circuit board; and
a guide member configured to guide a movement of the circuit board.

2. The camera module of claim 1, wherein
the guide member is configured to guide the circuit board to move in an optical axis direction, and prevent the circuit board from moving in a direction intersecting the optical axis direction.

3. The camera module of claim 1, wherein
the driving member comprises a shape memory alloy.

4. The camera module of claim 1, wherein
the driving member is connected to the guide member and an upper surface of the circuit board.

5. The camera module of claim 1, wherein
the driving member gradually expands as temperature decreases, at least, within a certain temperature range.

6. The camera module of claim 5, wherein
the elastic member is disposed under the circuit board.

7. The camera module of claim 5, wherein
the guide member comprises
a body portion coupled to a lower portion of the housing,
a neck portion disposed on the body portion, and
a head portion disposed on the neck portion.

8. The camera module of claim 7, wherein
the neck portion has a shape that widens from the body portion toward the head portion.

9. The camera module of claim 7, wherein
one side of the driving member is connected to a lower surface of the head portion.

10. The camera module of claim 1, wherein
the driving member is connected to the guide member and a lower surface of the circuit board.

11. The camera module of claim 1, wherein
the driving member gradually expands as the temperature increases, at least within a certain temperature range.

12. The camera module of claim 11, wherein
the elastic member is disposed on the circuit board.

13. The camera module of claim 11, wherein
the guide member comprises
a body portion coupled to an upper portion of the housing,
a neck portion disposed under the body portion, and
a head portion positioned under the neck portion.

14. The camera module of claim 13, wherein
one side of the driving member is connected to an upper surface of the head portion.
